(19) United States
(12) Patent Application Publication
(10) Pub. No.: US 2010/0235807 A1
(43) Pub. Date: Sep. 16, 2010

(54) Method and system for feature automation

(75) Inventors: Nagaraja Doddappa, Waltham, MA (US); David Oreper, Waltham, MA (US); Jonathan D. Vincent, Tyngsboro, MA (US)

Correspondence Address: LAW OFFICE OF DAVID H. JUDSON, 15950 DALLAS PARKWAY, SUITE 225, DALLAS, TX, 75248, US

(73) Assignee: HITACHI DATA SYSTEMS CORPORATION, Santa Clara, CA (US)

(21) Appl. No.: 12/405,036

(22) Filed: Mar. 16, 2009

(51) Int. Cl. G06F 9/44

(52) U.S. Cl. 717/101; 717/124; 717/106; 717/104

(57) ABSTRACT

A feature automation process defines step-by-step instructions for involving automation engineers, defining, implementing and reviewing software test automation during the development of a feature or product. This process seamlessly integrates the roles of automation engineers and other resources into the software development life cycle (SDLC). An enterprise first creates a dedicated automation team. The feature automation team preferably works with a product/feature team to enable the latter team to better understand the roles of the automation engineers and to further facilitate transparency into the product/feature requirements, design and implementation activities. The feature automation process enables a quality assurance (QA) team to offload (to the feature automation team) the responsibility of writing test scripts, and for creating an automation framework, test designs, and for implementing and maintaining test code. The process ensures that all stakeholders are involved in the reviewing the automation framework and test design prior to test implementation to enhance the reusability of the framework and the stability of the test runs.

### BACKGROUND OF THE INVENTION

1. Technical Field

The present invention relates generally to techniques for integrating software test automation into the design and development of a software product or feature.

2. Description of the Related Art

Software Development Life Cycle (SDLC) is a well-known concept in software engineering and refers to the process of creating or altering software systems. The SDLC is a logical process typically implemented by an entity and its employees (or consultants) to develop an information system, and it usually includes several phases, such as planning, analysis, design and implementation. A typical software development life cycle comprises a sequence of states in which the output of each stage becomes the input for the next. A representative sequence might be as follows: project definition, user requirements definition, system requirements definition, analysis and design, system build/prototyping (including coding and testing), and maintenance.

Traditionally, automated software testing is not an organizational focus by, rather, it is a by-product of ad-hoc automated tests from a quality assurance (QA) team. The development of such tests does not follow a repeatable process, nor is such software testing traditionally regarded as a primary role of any individual within a software development team. As such, no concrete procedure has been established within the software engineering industry to provide test automation that produces reliable, repeatable results.

Further, automated testing systems and methods are well-known in the prior art, as evidenced by the following representative patents: U.S. Pat. Nos. 6,662,312, 6,301,701, 6,002,869, 5,513,315 and 5,751,941. Known prior art testing frameworks also include solutions such as STAF (the Software Testing Automation Framework).

### BRIEF SUMMARY

This disclosure describes a software-based business process to automate manual testing of software applications. The “feature automation” process establishes concrete roles and responsibilities to be established and enforced for each member of a development team, and it gives visibility into each phase of development. This allows for predictable, high-quality and repeatable results. According to the process, software tools are used to execute automated tests and to collect results for analysis.

The feature automation process defines step-by-step instructions for involving automation engineers, defining, implementing and reviewing software test automation during the development of a feature or product. This process seamlessly integrates the roles of automation engineers and other resources into the software development life cycle (SDLC). An enterprise (and, in particular, management) first creates a dedicated automation team and, as necessary or desirable, allocates resources and builds expertise within this team. The feature automation team preferably works with the product/feature team to enable the latter team to better understand the roles of the automation engineers and to further facilitate transparency into the product/feature requirements, design and implementation activities. The feature automation process enables an associated quality assurance (QA) team to offload (to the feature automation team) the responsibility of writing test scripts, and for creating an automation framework, test designs, and for implementing and maintaining test code. The process ensures that all stakeholders are involved in the reviewing the automation framework and test design prior to test implementation to enhance the reusability of the framework and the stability of the test runs.

Preferably, the feature automation process is defined by a set of external review checkpoints, each of which includes one or more feature automation activities. The checkpoints preferably include: feature kick-off, high level review, detailed review, development and debugging, and the integration/test suite execution. Unlike the prior art, where software automation does not begin until late in the feature development life cycle, according to the described technique the requirements and design for automation begin at a much earlier phase.

In particular, using the approach described herein, the feature automation process begins much earlier in the development of the product/feature, and automation activities become integrated into the overall SDLC instead of merely being a late stage of the cycle. This process improves coordination from within and outside the automation team, improves the automation development framework, reduces the automation development life cycle, improves code quality and maintainability, improves code and test documentation, and reduces training time for new automation team members.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a process flow diagram illustrating the feature automation process flow according to an embodiment of the present invention;

FIG. 2 is a representative automated software testing framework for use in the feature automation process;

FIG. 3 is a process flow diagram illustrating component aspects of the feature kick-off phase;

FIG. 4 is a process flow diagram illustrating component aspects of the detailed review phase;

FIG. 5 is a process flow diagram illustrating component aspects of the feature kick-off phase;

FIG. 6 is a process flow diagram illustrating component aspects of the development/debug phase; and

FIG. 7 is a process flow diagram illustrating component aspects of the end game phase;

### DETAILED DESCRIPTION OF AN EMBODIMENT

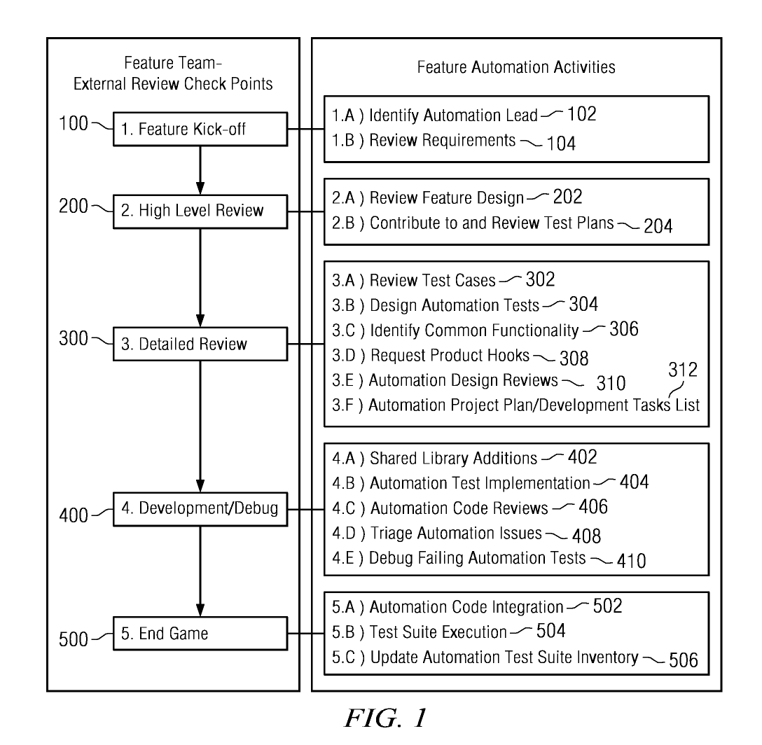

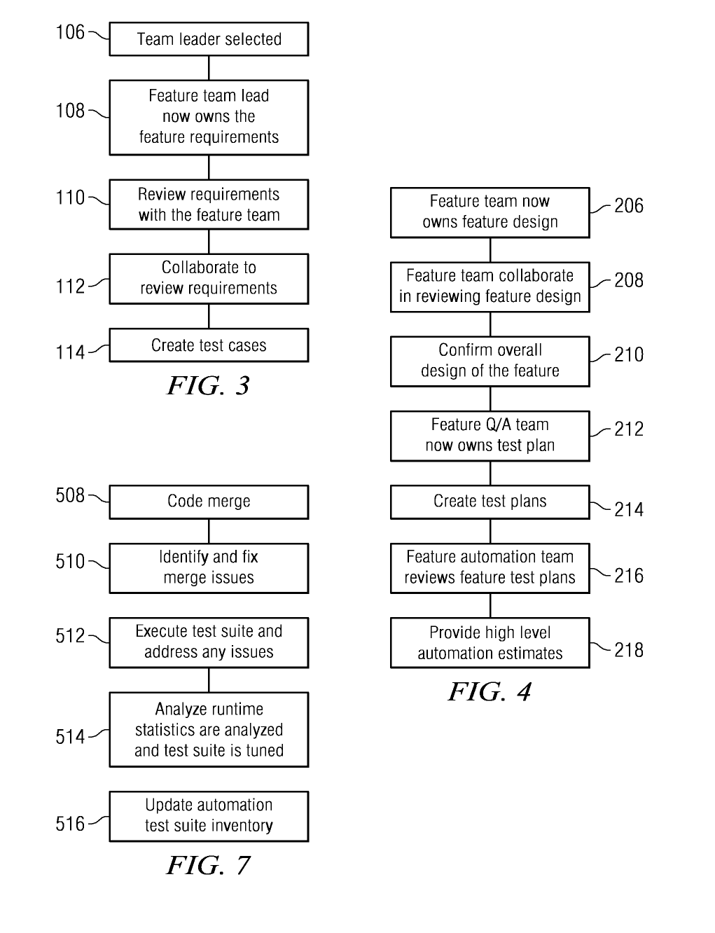

The reader should be familiar with basic terminology of software engineering. The feature automation process of this disclosure preferably includes a number of high level steps or phases that are illustrated in FIG. 1. Each of the component aspects of each phase will be described and/or defined in more detail below and as shown in FIGS. 3-7. The first step (phase) is feature kick-off, which is indicated by reference numeral 100. Thereafter, a high level review takes place, which is step 200. After the high level review, the next phase in the process is the detailed review phase 300. After the detailed level review phase, the next phase in the feature automation process is the development/debugging phase 400. Thereafter, the end game phase 500 completes the process.

Turning now to the more detailed aspects, and also with reference to FIG. 3, the feature kick-off phase 100 typically has a set of sub-steps, the first being identifying the feature automation leader 102. This step may be carried out by the feature team leader and/or the automation team leader, or some combination thereof, as indicated at step 106. Thereafter, the feature automation leader 102 reviews requirements, which is sub-step 104. The review requirements step typically has a number of aspects/tasks. As indicated by reference numeral 108, the feature team lead preferably owns the feature requirements after such requirements are frozen for the particular software release. Reference numeral 110 indicates that the feature team lead reviews requirements with the feature team. At step 112, a set of feature automation team members participate/collaborate in reviewing the requirements. Then, at step 114, the automation team members create one or more test cases (i.e., help QA in test plan and test case creation) and automate those test cases. This completes the review requirements step, and thus the feature kick-off phase 100.

The high level review 200 preferably includes two major phases: a review feature design phase 202, and a contribute/review test plans phase 204. Each of these will now be described.

With reference now to FIG. 4, the review feature design phase 202 begins at step 206 with the feature development team owning or being assigned the feature design. At step 208, the feature automation members participate/collaborate in reviewing the feature design. At step 210, the automation members come to understand the overall design of the feature; as such, they can recognize and request (from the feature development team) feature hooks and other interfaces as may be needed to implement the feature. This completes the review feature design phase 202. The contribute/review test plans phase 204 begins at step 212 with the feature QA team owning the test plan. At step 214, the feature automation team creates one or more test plans as needed for quality assurance. At step 216, the feature automation team participates in reviewing the feature test plans. This enables the feature automation team members to help understand the feature testing at a high level and, at step 218, to provide high level automation estimates. This completes the contribute/review test plans step 204, and thus the high level review phase 200.

The next phase is the detailed review 300, which has a number of sub-phases including a review test cases phase 302, a design automation tests phase 304, an identify common functionality phase 306, a request product hooks phase 308, an automation design review phase 310, and an automation project plan/development task lists phase 312. Each of the phases will now be described.

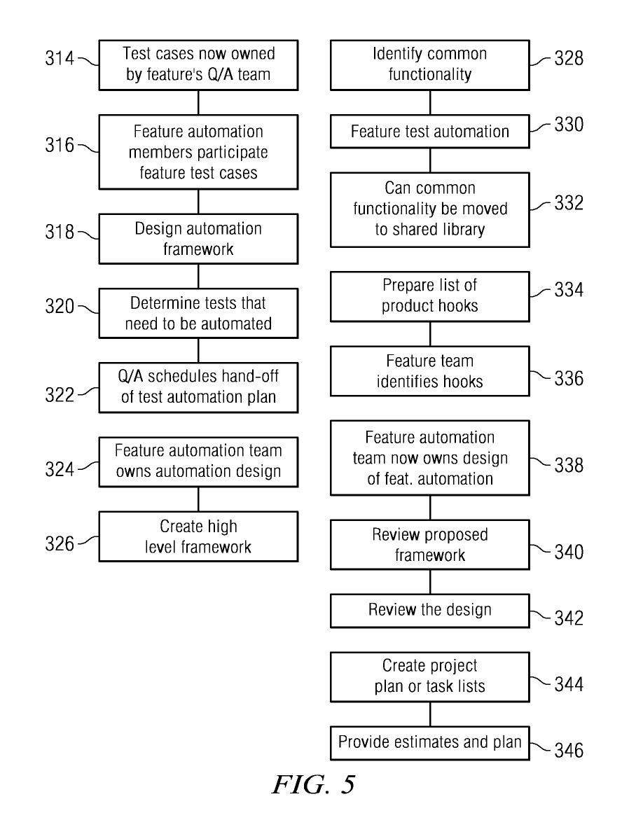

With reference now to FIG. 5, the review test cases phase 302 begins at step 314 with the test cases for the feature being owned or assigned by feature's QA team members. At step 316, the feature automation members participate/collaborate in reviewing the feature's test cases. At step 318, the reviews provide the feature automation team members an opportunity to understand the test cases and design an automation framework and, if needed, a common library. The sub-phase then continues at step 320 with further reviews as necessary to ensure that the feature automation team obtains a clear understanding of the tests that need to be automated. This ensures that there are no missing steps in any of the test cases. At step 322, the QA team meets to review the test automation plan and to evaluate the scenarios in detail. This completes the review test cases phases. The design automation tests phase 302 begins with the feature automation team owns the automation design. This is reference numeral 324. At step 326, the feature automation team creates a high level framework with a common library and sample tests cases. At this point, and before implementing the test cases, any necessary approval is obtained from the key reviewer and the feature team. This completes the design automation tests phase 304. In the next phase, which is referred to herein as the “identify common functionality” phase 306, the team identifies common functionality that can be used across feature tests and creates a feature-specific library. This is step 328. At step 330, the team uses the common functionality in the feature test automation. This phase then completes with step 332, during which the team evaluates the test results to determine if any of the common functionality can be moved to a shared library. The request product hooks phase 308 begins at step 334 with the feature automation team preparing a list of product hooks that are expected to be needed after the test and feature design reviews. The product hooks are identified by the feature development team. At step 336, the feature development team identifies the hooks, which can be in any convenient forms such as an SNMP interface, administrative commands, database queries, and so forth.

The automation design review phase 310 begins at step 338 with the feature automation team owning the design of the feature automation. At step 340, the feature automation key reviewer reviews the proposed framework, shared library additions and a sample test case implementation for one or more of the following types of tests as applicable to the type of feature: an acceptance test suite, a functional test suite, and a stress test suite. At step 342, the feature automation team reviews the design with the key reviewer in one or more phases. Finally, the automation project plan/development task lists phase 312 begins with the feature automation team creating a formal project plan or development task lists, preferably with time and cost estimates. This is step 344. At step 346, the automation plan and estimates are provided to the feature team lead to be added to the feature development plan. This enables design progress to be tracked. This completes the detailed review phase 300.

The development/debug phase 400 has a number of sub-phases: a shared library additions phase 402, an automation test implementation phase 404, an automation code reviews phase 406, a triage automation issues phase 408, and a debug automation tests phase 410. Each of these phases will now be described.

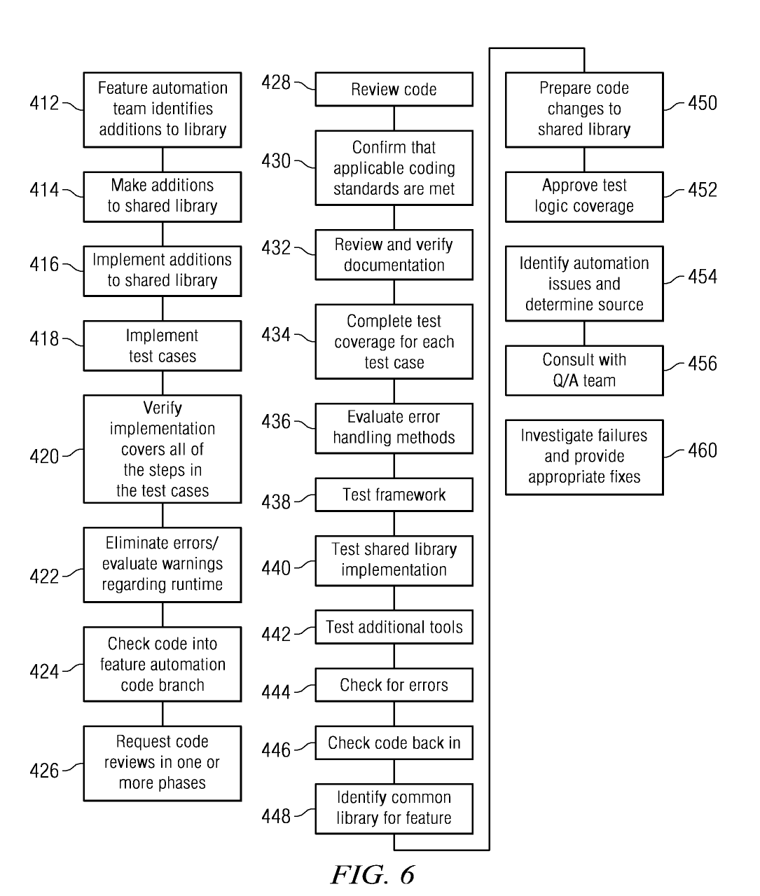

Referring now to FIG. 6, the shared library additions phase 402 begins at step 412 with the feature automation team identifying one or more additions to the shared library. These recommendations typically are made after the team undertakes and completes a through review of the feature design and test plans. At step 414, the feature automation team makes one or more additions to the shared library as needed. These additions typically will depend on the type of feature being developed. Thus, for example, if the feature is new, there are likely to be more additions than if the feature is an incremental enhancement or modification. At step 416, the additions to the shared library are implemented. This completes the shared library additions phase 402, at which point the automation test implementation phase 404 begins. At step 418, the team implements one or more test cases that have been identified (by the feature team) for automation. At step 420, the team verifies that the implementation covers all of the steps identified in the test cases. At step 422, the team runs an appropriate process (e.g., PyChecker) and eliminates any errors and/or evaluates warnings for any potential runtime issues. Thereafter, at step 424, the team checks in the code to the feature automation code branch. At step 426, the code reviewer makes a request for code reviews in one or more phases. This completes the automation test implementation phase 404.

The automation code reviews 406 phase is then initiated. It begins at step 428 with the feature automation team reviewing the code with the key reviewer(s), which could be from the current feature automation team, or others. At step 430, a review is carried out to confirm that any applicable coding standards are met. At step 432, any documentation is reviewed. At step 434, complete test coverage for each test case is carried out. At step 436, error handling methods are evaluated. At step 438, the framework is tested. At step 440, the shared library implementation is tested. At step 442, any additional tools that may be required are then tested. At step 444, any appropriate process (such as PyChecker) is run to check for errors. The code is then checked back in to the code branch at step 446. At step 448, the common library for the feature is identified. At step 450, the changes or additions to the shared library (if any) are made. At step 452, when the code is complete for tests, the team meets with QA and obtains approval on test logic coverage. This completes the automation code review phase 406.

The triage automation issues phase 408 begins at step 454. At this stage, any automation issues (i.e., bugs) that are related to the feature are identified and a determination is made regarding the source of the issue. At step 456, the team involves the QA team and then, if necessary, the development team to attempt to determine whether the test failure is due to a product issue and how it might be addressed. This completes triage automation issues phase 408. Finally, the debug automation tests phase 410 then involves step 460, during which the team investigates any failures and provides appropriate fixes until all tests pass. This completes the development/debug phase 400.

Although not meant to be limiting, preferably one or more off-the-shelf tools may be used for developing and reviewing automation code. These include Eclipse (a software development environment), PyDev (a plugin that enables users to use Eclipse for Python development), PyChecker (a tool for finding bugs in Python source code) and PyLint (a Python tool that checks if a module satisfies a coding standard). These tools are merely representative.

The end game phases 500 has a number of sub-phases: an automation code integration phase 502, a test suite execution phase 504, and an update test suite inventory phase 506. Each of these phases will now be described.

Referring now to FIG. 7, the automation code integration phase 502 begins at step 508 with a code merge. Thereafter, the team identifies and fixes any remaining issues. This is step 510. This completes the automation code integration phases 502. The test suite execution phase 504 begins at step 512. At this step, the team executes the test suite and addresses any issues that arise (in the feature test suite, and all other dependent test suites). At step 514, runtime statistics are analyzed and the test suite is tuned for performance purposes if necessary. This completes the test suite execution phase. Finally, the update test suite inventory phase 506 is carried out. During this final step, at step 516, the feature automation team updates an automation test suite inventory reflecting any changes to the existing test suites.

The disclosed subject matter has many advantages. The described methodology may be used by any software product development organization and easily integrated into the software development lifecycle. This has the benefit of streamlining the SDLC process and reducing overall workload for each member of the development team while improving overall product quality. Automation provides the following additional benefits: facilitates the definition of an automation team for new product development, reduces the product development lifecycle by weeks/months where periodic (e.g., bi-annual) releases are required by identifying product bugs earlier in the development cycle, provides continuous feedback on product quality, enables feature teams to work more cohesively to deliver a higher quality product, and it provides the ability to define and enable a robust and reliable automation platform for any software development project. The methodology provides a repeatable process that can be used or tailored to define a software test automation environment in an organization's software product development initiatives. It further defines a new software organizational model to enable an entity to move towards achieving software Quality Assurance (Q/A) through test automation.

The process can be used in many ways. Organizations in the software product testing industry can use this methodology to define and execute their test automation strategies. Organizations involved in complex software product development can use the methodology to define and execute their automation development activities. Others, such as software process consulting organizations may use the methodology to improve product quality and reduce testing costs for their clients.

Although not meant to be limiting, step 512 in FIG. 7 may be implemented using a software automation tool as described in commonly-owned U.S. Publication No. 20070234293, titled “Automated testing software framework,” may be used for this purpose. Such an automated testing framework preferably is implemented as program code executable in a machine (or across multiple machines). The particular machine details or operating environment are not particularly relevant. In one embodiment of that approach, the code operates as a standalone application or “daemon” that calls other modules that perform the various functions required by the framework. One or more of such modules may be native to the framework or part of some external system. The daemon may execute on one machine while one or more of the service modules execute on the same or other machines. This ensures cross-platform compatibility of the framework.

In one embodiment, the framework daemon has a number of supporting tools, namely, executable modules, that provide the various functions required. For example, framework daemon runs test suites (or batches), records the results in a database, and stores node images and logs in a web-accessible directory on a local machine's web server. The daemon preferably emails all exceptions, failures, crashes and the like to a target set of email recipients, or otherwise exports such information to a bug tracking system. Thus, the framework provides a functional, cluster level regression test running harness that is highly configurable and that is test language agnostic. The framework also is capable of running white-box testing. Any test that can run on a series of hosts, or even a single host, can be run within the automated test framework.

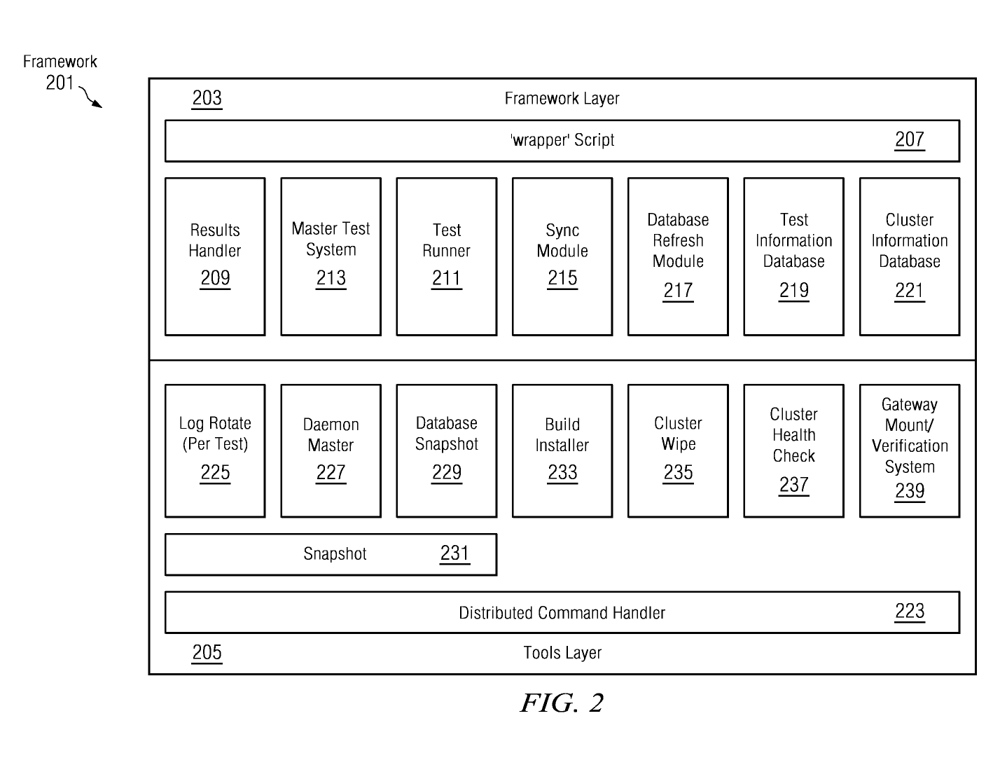

Referring now to FIG. 2, a block diagram is shown of a particular implementation of the automated testing framework for use, for example, in step 512 of FIG. 7. As has been described, the framework is a toolbox with a wrapper in the form of the daemon. It is an extensible framework that provides functional testing, preferably built with common, extensible, simple tools.

As illustrated in FIG. 2, the framework 201 according to the embodiment has two layers: a framework layer 203, and a tools layer 205. The framework layer 203 comprises any logic, modules, scripts or databases that may be required to the framework to “know” about the framework, the product/system under test, and the required tests (and execution of those tests). The tool layer 205, in contrast, comprises those tools that facilitate the de-centralized management of the system and perform various tasks including, without limitation, build installation, log management, database queries, and the like. Preferably, the tools (or at least some of them) are non-interactive, automated and re-usable, and do not require centralized management or control.

Referring now to FIG. 2, the daemon 207 is a network-accessible script that allocates, installs, and verifies the system under test (SUT) by leveraging separate logical modules. The daemon listens for inbound requests to run a given suite against a target system under test. The results handler module 209 manages the data generated during the tests. Thus, for example, by default results are records in a results directory, which is preferably keyed by date/time/suite/test name. Results for each test may be stored as a flat text file format and uploaded into a current results database system. After a run is complete, if a results upload flag is enabled, the daemon 207 uploads these results into a results database. The results handler module 209 also may email the results in a CSV-style format for uploading into another system, and it may push those results into a database, or store the results in files on a disk for maximum accessibility. The test runner module 211 is a script that is ultimately responsible for the execution of the actual test suite. This script handles all details required for the test (e.g., configuring, initializing resources, and the like). This module preferably executes tests in a non-blocking/timed out manner. It expects tests to hang, or to not complete; it monitors those tests and kills them as needed. The master test system module 213 uses the test runner module 211 and generates master level suites (framework suites, as opposed to individual suites) to serve as a batching system for system-level categories (e.g., long burn in, quick smokes, performance, and the like). The code repository synchronization module 215 is responsible for handling all repository (e.g., Perforce) refreshes and for pulling the code builds from the source control server. A database module tells this module where to find the required tests, and whether or not to refresh those tests. If a test must be refreshed, this module downloads those tests directly from the repository. Preferably, the code repository synchronization module synchronizes files for a given test suite, irrespective of whether it has a local copy. Thus, the source control system is deemed to be the master copy; the framework, in contrast, does not trust its local copies. The database refresh module 217 handles any and all database connectivity. This module is used to get information about the cluster, and to provide that information to the daemon. The refresh module 217 is also used to get required test/suite information. The test information database 219 is a database that comprises information about each test in a test suite, as well as any required information for any such test to execute. The cluster information database 221 comprises any pertinent information about the clusters against which the framework will be exercised. This database may be polled before any test run (or before a given test suite is run) to find the required information.

The tools layer 205 components comprise a distributed command handler module 223 that is a wrapper to the tools in the layer. The module 223 preferably is accessible via an SSH connection to enable the tools to interact with the cluster non-interactively, or via scripts or an open API. Access to the distributed command handler module preferably requires authentication. A log rotate or “imager” module 225 dumps system logs, checks for error messages in the cluster node logs, and images databases across the cluster nodes after a test is complete. A daemon master module 227 is a script that allows granular control over daemons on the system under test, such as starting and stopping. A database snapshot module 229 is provided to grab a snapshot 231 of the databases spread out across the SUT, and pulls those snapshots back to the local machine. The snapshot module 229 is a tool that actually images the SUT, and it may operate with the log rotate module to get the logs from all of the SUT nodes in between the various test runs of a given test suite. The snapshot module 229 also grabs an image of a current database on all the nodes in the system, copies those files back to the local machine, and stores them alongside the logs for that test/suite run. The snapshot module may also verify a cluster's integrity. A build installer module 233 is a script that leverages the distributed command handler module to install the defined build across the target cluster, including any and all required configuration scripts. The module 233 may be implemented as script that automatically determines the required values based on information in a configuration database. A module 235 wipes or cleans the target system non-interactively, formatting the disks, database, logs, files, and the like, if necessary. A health monitor 237 is a script that verifies the integrity of a running system, also checking for valid/invalid processes, swap usage, and the like. At any point, the health monitor 237 is called to check up on the SUT. Finally, a gateway mount verification module 239 is used to verify the health of the various gateways and to perform various access methods against those gateways; this module thus operates to verify availability of a given cluster (and the nodes within that cluster). The module may also be used as a mounting system for the test runner module to call to mount required resources.

It should be noted that the tools shown in FIG. 2 are not necessarily exhaustive or exclusive, as various other tools and modules may be used by the framework Moreover, the line in FIG. 2 between the tools layer and the function/daemon layer is merely representative and should be taken to limit the scope of the invention in any way. As noted above, the framework (regardless of how implemented) is merely a platform that simply drives the tests while providing them a “clean room” in which to operate, all the while ensuring state as the test suite progresses. In a representative embodiment, the automated testing framework executes on a machine running commodity hardware and the Linux operating system. This is not a limitation, however. As noted above, the daemon may be executed on a given machine while one or more of the modules illustrated in FIG. 2 may operate on the same machine or on one or more other machines. Thus, the framework also has the ability to allocate for, and leverage non-Linux based clients, such as clients that execute on Solaris, HPUX, AIX, IRIX, OS/X, WinXP, Windows 2000, or the like. Thus, in an alternative embodiment, the framework includes appropriate functionality to detect a given test's platform and, upon detection, to push execution of the test off to a specific platform that can support it.

As noted above, any of the machines illustrated may be run different hardware, different software, or different hardware and different software. As a result, the framework is highly scalable. It is flexible, easily extensible, and preferably test-language and client-platform agnostic. This implementation ensures that the framework can run any test, in any language.

While the process flow diagrams and the above description provide a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the present invention has been described in the context of a method or process, the subject matter herein also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. As noted above, a given implementation of the present invention is software written in a given programming language that runs on a standard hardware platform running an operating system such as Linux.

While given components of the system have been described separately, one of ordinary skill will appreciate that some of the functions may be combined or shared in given instructions, program sequences, code portions, and the like.

Having described our invention, what we claim is as follows:

1. In a software development life cycle that comprises requirements gathering and analysis, design, implementation, testing and integration phases, an improvement comprising:
identifying an automation team;
having the automation team review a software design and at least one test plan;
based on the review, having the automation test design at least one automation test;
generating code for performing the at least one automation test;
integrating the code with code that implements a given software feature to be tested; and
executing at least one test suite against the integrated code;
wherein at least one of the above-identified steps is machine-implemented.

2. The improvement as described in claim 1 further including identifying and correcting any errors in the integrated code that are identified during the executing step.

3. The improvement as described in claim 1 wherein the at least one test suite is executed during the executing step using an automated testing framework.

4. The improvement as described in claim 1 further including tuning the test suite as a function of data collected during the executing step.

5. The improvement as described in claim 1 further including having the automation team create an automation framework that includes the at least one automation test.

6. The improvement as described in claim 5 wherein the automation framework comprises a common library and a set of sample test cases that include the at least one automation test.

7. The improvement as described in claim 1 wherein the automation team also identifies common functionality that is to be used across a set of feature tests for the given software feature.

8. The improvement as described in claim 7 further including determining whether any common functionality can be moved into a shared library.

9. The improvement as described in claim 8 further including moving components of the common functionality into the shared library.

10. A method of software development, comprising:
identifying an automation team;
having the automation team review a software design and at least one test plan;
based on the review, having the automation test design at least one automation test;
generating code for performing the at least one automation test;
integrating the code with code that implements a given software feature to be tested; and
executing at least one test suite against the integrated code;
wherein at least one of the above-identified steps is machine-implemented.
